(19) United States
(12) Patent Application Publication
(10) Pub. No.: US 2003/0214495 A1
(43) Pub. Date: Nov. 20, 2003

(54) Display unit with variable noise filter

(75) Inventor: Satoshi Koyama, Kato-gun (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/427,883

(22) Filed: May 2, 2003

(30) Foreign Application Priority Data
May 15, 2002 (JP) 2002-140321

(51) Int. Cl. G09G 5/00

(52) U.S. Cl. 345/204

(57) ABSTRACT

An image display unit includes a variable filter for removing a noise signal superposed on a video signal. The display unit also includes a frequency determiner for determining the frequency of the noise signal. The cut-off frequency of the filter is adjusted in accordance with the determined frequency of the noise signal.

### BACKGROUND OF THE INVENTION

1. Field of the Invention

The present invention relates to a unit for displaying images based on video signals, for example.

2. Description of the Related Art

Conventionally, a typical desktop personal computer system includes a main unit incorporating a CPU, a display unit provided with a liquid crystal display panel for example, and a keyboard connected to the main unit.

As the signal processing by the CPU becomes faster, various noises are generated in the main unit. Unfavorably, these noises tend to mix with the analog video signals transmitted from the main unit to the display unit through the connection cable.

A typical way to cope with such a problem is to provide a noise-removing filter between the main unit and the display unit. FIG. 10 is a block diagram illustrating the internal arrangement of a prior art display unit connected to the main unit. As shown in the figure, the display unit 30 is generally made up of a filter 31, an A/D converter 32, a PLL (phase locked loop) 33, a data processor 34, a CPU 35 and a liquid crystal display device 36.

In the conventional system, video signals transmitted from a main unit 40 via the connection cable 41 are inputted to the filter 31, where unwanted noise signals are removed from the video signals. Then, in the A/D converter 32, the video signals are subjected to A/D conversion based on the control signal supplied from the PLL 33. Thereafter, in the data processor 34, the video signals are converted into image signals in accordance with instructions from the CPU 35. As a result, the desired image is displayed at the display device 36.

The conventional display unit has been found disadvantageous in the following respect.

Specifically, the filter 31 of the prior art unit, which may be a low-pass filer, has a fixed cut-off frequency. Accordingly, the frequency range of removable noise signals is fixed. With such a fixed removal range, however, the filter 31 may serve as a barricade to the video signal when the frequency of the video signal becomes high (e.g. 200MHz or more).

### SUMMARY OF THE INVENTION

The present invention has been proposed under the circumstances described above. An object of the present invention is to provide a display unit which is capable of outputting a high quality image by removing noise signals mixed with video signals in accordance with the frequencies of the noise signals.

According to the present invention, there is provided a display unit comprising: a variable filter for removing a noise signal superposed on a video signal; and a frequency determiner for determining a frequency of the noise signal. The filtering characteristic of the filter is adjusted based on the determined frequency of the noise signal.

With the above arrangement, the filtering characteristics of the filter can be optimized based on the determined frequency of the noise signal. Thus, by adjusting the filtering characteristics, the noise signal is properly removed, while the required video signal can pass through the filter.

Preferably, the filtering characteristic may be a cut-off frequency of the filter.

Preferably, the frequency determiner may comprise: a clock signal generator that generates a clock signal higher in frequency than a reference clock signal; a sampler that samples the noise signal in accordance with the generated clock signal; a level detector that detects a level of the sampled noise signal; and a frequency calculator that calculates the frequency of the noise signal based on the detected level of the sampled noise signal.

Preferably, the higher-frequency clock signal may be generated by multiplication of the reference clock signal, by delaying the reference clock signal, or by shifting the phase of the reference clock signal.

Other features and advantages of the present invention will become clearer from the detailed description given below with reference to the accompanying drawings.

### BRIEF DESCRIPTION OF THE DRAWINGS

FIG. 1 is a perspective view illustrating a personal computer system including a display unit according to a first embodiment of the present invention;

FIG. 2 is a block diagram illustrating the principal components of the display unit;

FIG. 3 illustrates the relationship between a video signal and a synchronization signal;

FIG. 4 illustrates the relationship between a noise signal and a clock signal in the display unit of the present invention;

FIG. 5 illustrates the filter characteristics of a variable filter used in the display unit of the present invention;

FIG. 6 is a block diagram illustrating the principal components of a display unit according to a second embodiment of the present invention;

FIG. 7 illustrates the relationship between a noise signal and a clock signal in the display unit of the second embodiment;

FIG. 8 is a block diagram illustrating the principal components of a display unit according to a third embodiment of the present invention;

FIG. 9 illustrates the relationship between a noise signal and a clock signal in the display unit of the third embodiment; and

FIG. 10 is a block diagram illustrating a prior art display unit.

### DETAILED DESCRIPTION OF THE PREFERRED EMBODIMENTS

Preferred embodiments of the present invention will be described below in detail with reference to the accompanying drawings.

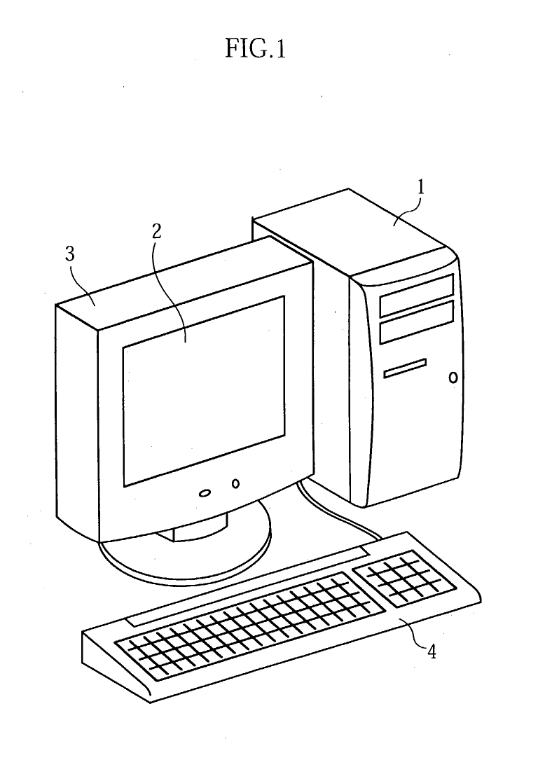

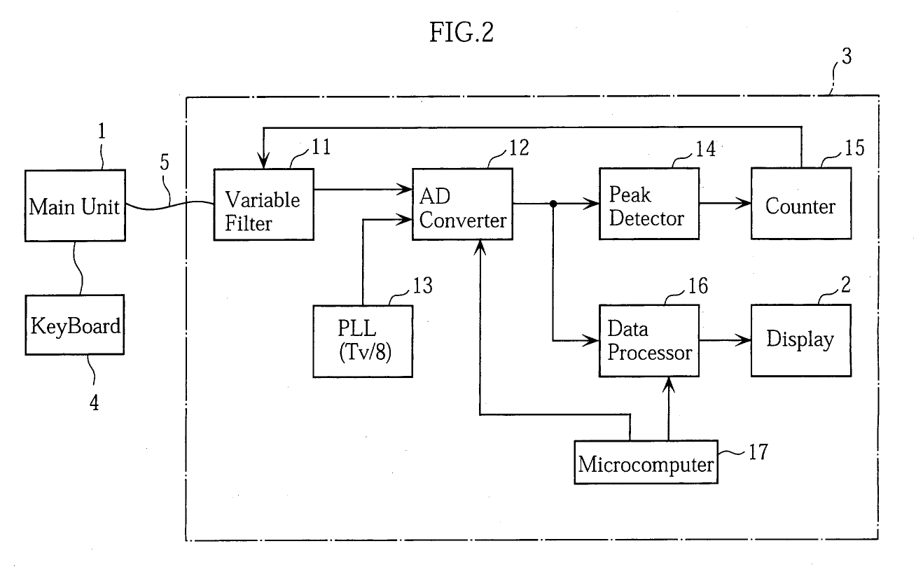

FIG. 1 is a perspective view illustrating a personal computer system including a display unit according to a first embodiment of the present invention. The personal computer system includes a main unit 1 incorporating a CPU, a display unit 3 provided with a liquid crystal display device 2, and a keyboard 4 connected to the main unit 1. The main unit 1 is connected to the display unit 3 via a connection cable 5 (see FIG. 2) for transmitting RGB video signals.

Referring to FIG. 2, the display unit 3 comprises a variable filter 11, an A/D converter 12, a PLL 13, a peak detector 14, a counter 15, a data processor 16, and a microcomputer 17. The above-mentioned display device 2 is connected to the data processor 16. It should be appreciated that the arrangement of the display unit 3 shown in FIG. 2 is for processing only R(red) signals, for example. Actually, the display unit 3 includes similar arrangements for processing G signals and B signals.

The variable filter 11, which may be a low pass filter for example, removes a noise signal superposed on a video signal transmitted from the main unit 1. The variable filter 11 can vary its resistance, thereby adjusting the cut-off frequency, in accordance with the frequency of the noise signal.

The PLL 13 provides the A/D converter 12 with a sampling clock. Specifically, the PLL 13 may output a sampling clock of a frequency eight times that of a reference clock Tv (which synchronizes with the cycle of the video signal).

The A/D converter 12 converts analog signals to digital signals in accordance with the sampling clock from the PLL 13. The analog signals to be converted include video and noise signals that have passed through the variable filter 11.

The peak detector 14 operates in accordance with the instructions from the microcomputer 17. The detector 14 determines the peak value of a noise signal mixing with the video signal after these signals are converted from the analog to the digital signals by the A/D converter 12.

The counter 15 counts or measures the period of time from one peak value of the noise signal to the next peak value. In this way, it is possible to determine the cycle of the noise signal, and hence the frequency of the noise signal.

The data processor 16 receives the digital video signals from the A/D converter 12. Based on the instructions from the microcomputer 17, the dataprocessor 16 converts the video signal into an image signal.

The microcomputer 17 may consist of a CPU and an associated main memory. The microcomputer 17 transmits process execution signals to the A/D converter 12 and the data processor 16.

The operation of the display unit 3 will now be described below.

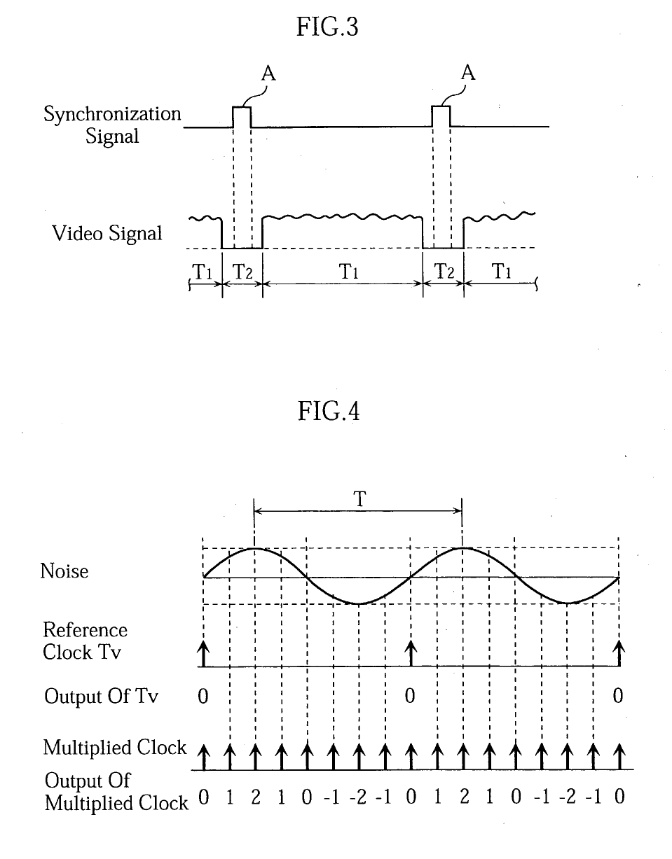

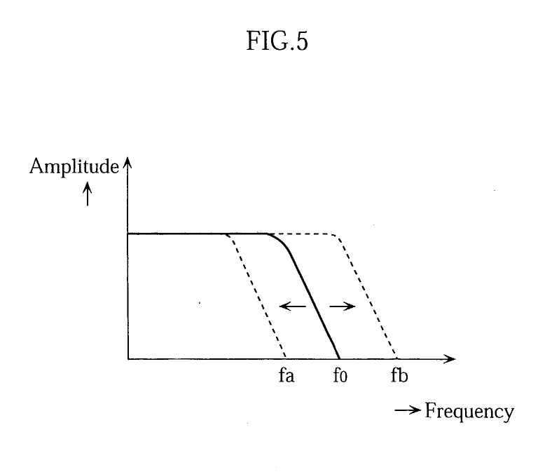

Referring to FIG. 3, the video signal transmitted from the main unit 1 to the display unit 3 has active periods T₁ each of which is flanked by two blanking periods T₂. The video signal is outputted to the display unit 3 from the main unit 1 in accordance with a synchronization signal (two pulses A are shown in FIG. 3). The active period T₁ of the video signal, which corresponds to one horizontal scan line, lies between the adjacent pulses A of the synchronization signal. The video signal in the active period T₁ may have a substantially constant voltage (about 0.7 Vp-p). The blanking period T₂ may last for 1 μsec, for example, in which the output of the video signal to the display unit 3 is interrupted. According to the present invention, the frequency of the superposing noise signal is detected during the blanking period T₂.

The noise signal includes high frequency components in comparison with the video signal. Thus, the detection of the noise signal frequency cannot be performed properly when the noise signal sampling is conducted at the timings of the reference clock with which the video signal synchronizes. In light of this, the noise signal sampling of the present invention is performed in accordance with a faster sampling clock whose frequency is a multiple of the reference clock's frequency. Then, based on the detected noise frequency, the filtering characteristics of the filter 11 is adjusted so that the noise signal superposed on the video signal is removed, while the video signal passes through the filter.

More specifically, as shown in FIG. 4, the PLL 13 outputs, to the A/D converter 12, a sampling clock having a frequency eight times the frequency of the reference clock Tv. The A/D converter 12 samples the noise signal at the timings in accordance with the sampling clock (in other words, the converter 12 converts the analog noise signal into a digital signal). The respective pieces of the sampled data may have a level of 0, +1, −1, +2, −2, and so on, as shown in FIG. 4.

The detected levels of the sampled data are supplied to the peak detector 14 in accordance with the sampling clock. The peak detector 14 detects the timings when the noise signal reaches the peak level (the peak level is “2”in the example shown in FIG. 4). Then, the peak detector 14 outputs the detected timings to the counter 15.

Based on the output from the peak detector 14, the counter 15 picks up a plurality of timings when the noise signal reaches the peak level. Then, the counter 15 determines the cycle of the peak level (i.e. the length of time between the adjacent peak levels) and outputs the cycle to the variable filter 11. In the example of FIG. 4, the peak level cycle detected by the counter 15 is indicated by the reference sign T.

Upon receiving the data on the peak level cycle T, the variable filter 11 performs cut-off frequency adjustment by changing the current cut-off frequency f₀ to a lower frequency fa or to a higher frequency fb. For example, when the frequency of the video signal is about 200MHz and the frequency of the noise signal is about 300MHz, a resistance component incorporated in the variable filter 11 may be varied to shift its cut-off frequency f₀ so that the noise signal components in a frequency band above 300MHz or so are removed.

The video signal, from which the noise signal has been removed by the variable filter 11, is snet to the A/D converter 12 to be converted into a digital signal. The digital video signal thus obtained is sent to the data processor 16.

The data processor 16 converts the digital video signal into an image signal to be outputted to the display device 2. The display device 2 displays the image based on the image signal from the data processor 16.

According to the above embodiment, the cut-off frequency of the filter 11 can be varied in accordance with the detected frequency of the noise signal superposing the video signal. Thus, the removal of the unwanted noise is properly performed.

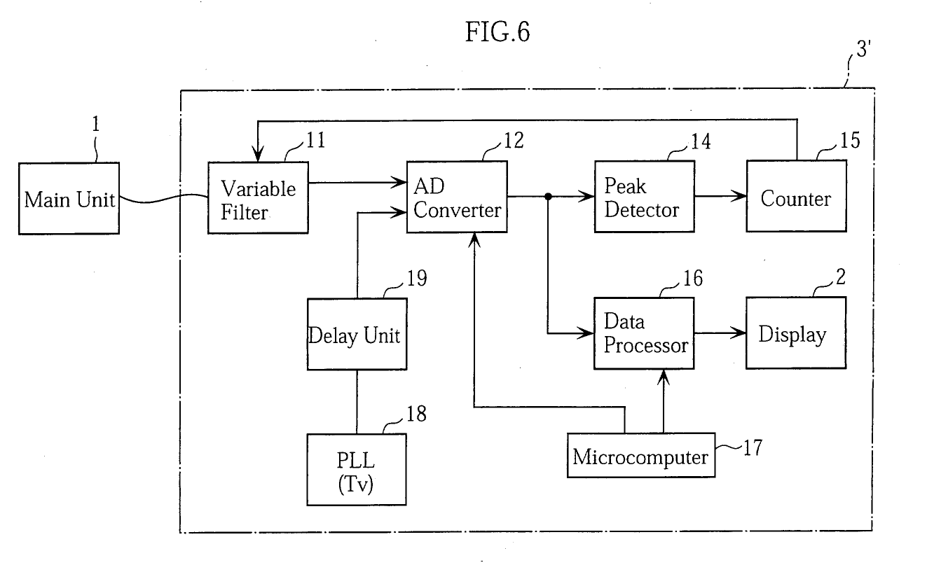

Referring to FIG. 6, a second embodiment of the present invention will be described below. In the first embodiment described above, the sampling of a noise signal is performed by using the PLL 13, which outputs a sampling clock whose frequency is a multiple of the frequency of the reference clock. In the second embodiment, a sampling clock, higher in frequency than the reference clock, is generated by delaying the output of the reference clock in the manner described below. As in the first embodiment, the obtained higher-frequency sampling clock is used for performing the noise signal sampling.

As seen from FIG. 6, the display unit 3′ of the second embodiment is basically the same in design as the display unit 3 of the first embodiment, except that the display unit 3′ is provided with a PLL 18 for outputting a reference clock Tv synchronizing with the video signal, and with a delay unit 19 connected to the PLL 18.

The delay unit 19 delays the reference clock Tv outputted from the PLL 18 by a predetermined period of time and outputs a plurality of delayed reference clock signals to the A/D converter 12 at predetermined timings.

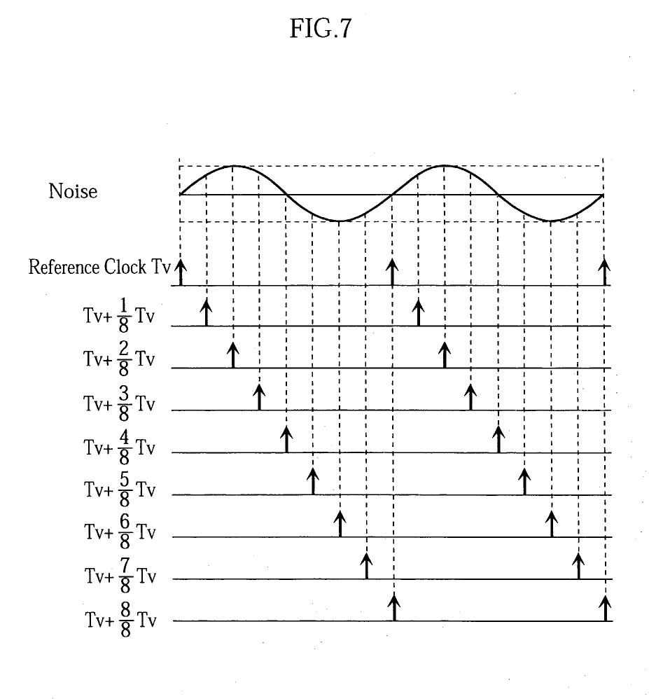

With this arrangement, as shown in FIG. 7, the reference clock Tv from the PLL 18 is delayed by n/8 cycle (n=1˜8) by the delay unit 19 and outputted as a converted sampling clock of a frequency higher than that of the reference clock Tv. Thereafter, the noise signal is sampled at the A/D converter 12 based on the sampling clock, and the frequency of the noise signal is measured by the peak detector 14 and the counter 15.

In the second embodiment again, the filtering characteristics of the variable filter 11 varies in accordance with the frequency of a noise signal, thereby reliably removing the noise signal.

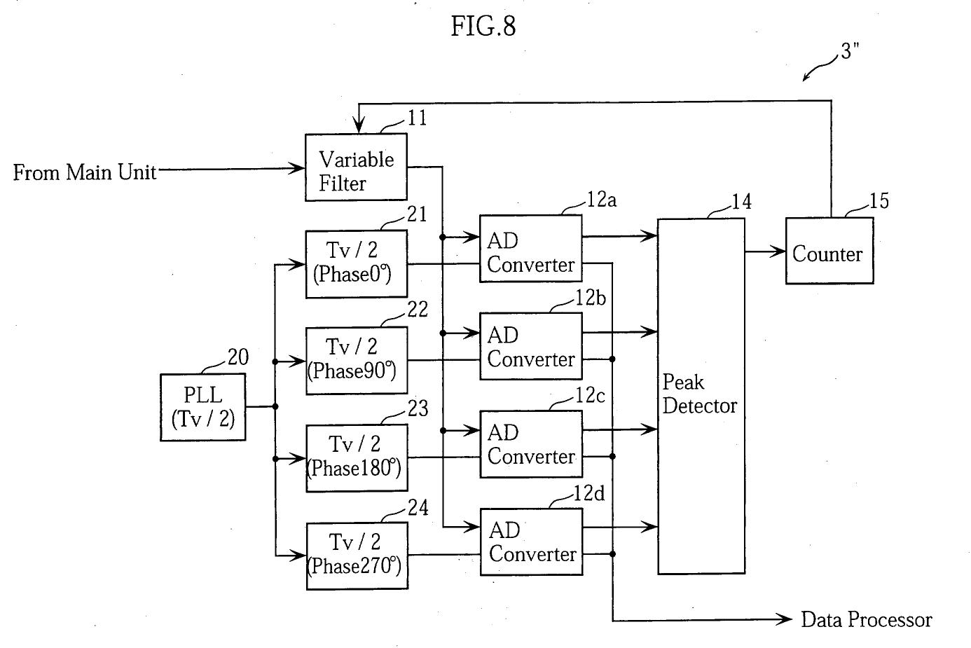

Referring to FIG. 8, a third embodiment of the present invention will be described. In this embodiment, a sampling clock having a frequency higher than that of a reference clock is outputted by shifting the phase of the reference clock, as described below, and a noise signal is sampled using the sampling clock.

As seen from FIG. 8, the display unit 3″ of the third embodiment is basically the same as the display unit 3 of the first embodiment except that the display unit 3″ is provided with a PLL 20 for outputting a second subharmonic reference clock (or half reference clock), i.e. a clock whose cycle is one half that of the reference clock Tv. The PLL 20 is connected to a plurality of phase delay units 21-24 in parallel.

The above phase delay units include a first phase delay unit 21 which does not shift the phase of the half reference clock, a second phase shift unit 22 which shits the phase of the half reference clock by 90°, a third phase shift unit 23 which shits the phase of the half reference clock by 180° and a fourth phase shift unit 24 which shits the phase of the half reference clock by 270°. Each of the phase delay units 21-24 is connected to an A/D converter 12 connected to a peak detector 14. Each A/D converter 12 receives the output from the variable filter 11. Though the display unit 3″ includes a data processor, a display device and a microcomputer as those incorporated in the previous embodiments, these components are not shown in FIG. 8.

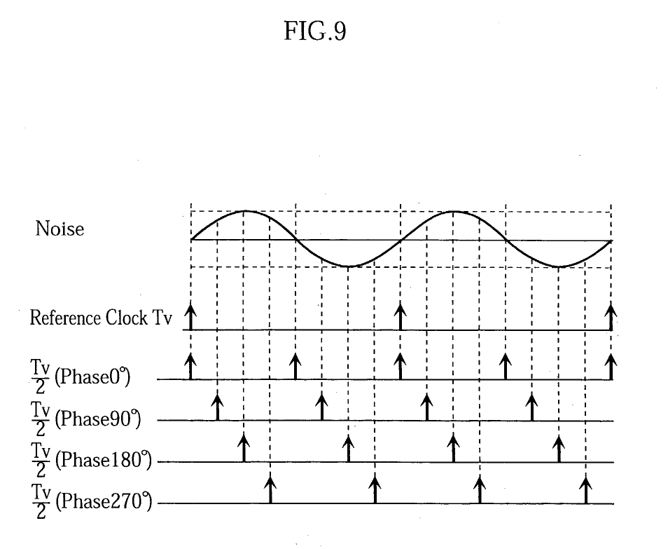

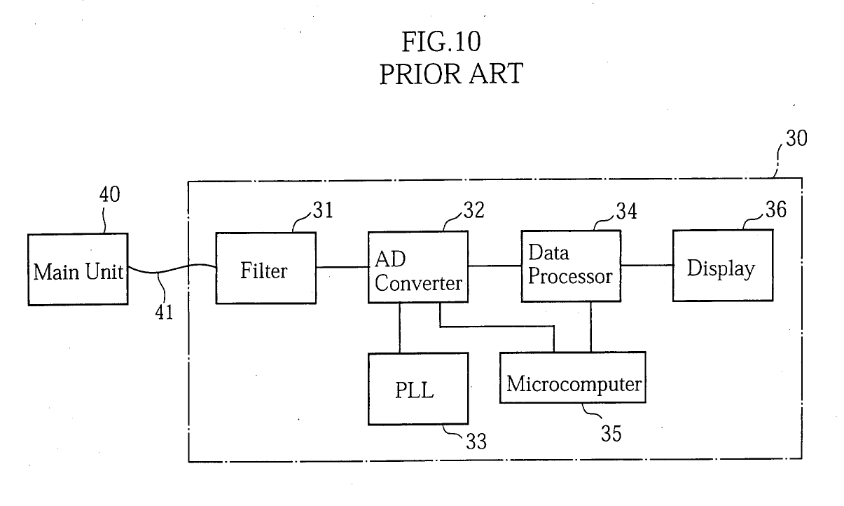

With this arrangement, referring to FIG. 9, the first phase shift unit 21 outputs a 0°-phase sampling clock signal Tv/2 successively at the half cycle of the reference clock signal Tv. Likewise, the second through the fourth phase shift units 22˜24 output 90°-, 180°-, and 270°-phase sampling clock signals Tv/2, respectively, at the half cycle of the reference clock signal Tv.

In the third embodiment again, as seen from FIG. 9, the noise signal sampling can be performed eight times at regular intervals during each one cycle of the reference clock Tv in accordance with the four kinds of sampling clocks Tv/2. More specifically, the 0°-phase sampling clock signal Tv/2 is inputted to the first A/D converter 12a in which the noise signal sent from the variable filter 11 is subjected to the signal sampling based on the 0°-phase sampling clock signal Tv/2. Likewise, the 90°-phase sampling clock signal Tv/2 is inputted to the second A/D converter 12b in which the same noise signal sent from the filter 11 is subjected to the signal sampling, and so on. The sampling results from the respective A/D converters 12a˜12d are sent to the peak detector 14. Then, the peak detector 14 determines what timings the peak values of the noise signal are attained at. The results are sent to the counter 15 for detection of the frequency of the noise signal superposed on the video signal. Thereafter, based on the detected frequency of the noise signal, the filtering characteristics of the filer 11 is changed for enabling proper noise removal.

According to the third embodiment, the sampling clock signals are generated without using a relatively expensive PLL, which is advantageous to reducing the cost.

The present invention being thus described, it is obvious that the same may be varied in many ways. Such variations are not to be regarded as a departure from the spirit and scope of the present invention, and all such modifications as would be obvious to those skilled in the art are intended to be included within the scope of the following claims.

1. A display unit comprising:
a variable filter for removing a noise signal superposed on a video signal; and
a frequency determiner for determining a frequency of the noise signal;
wherein a filtering characteristic of the filter is adjusted based on the determined frequency of the noise signal.

2. The display unit according to claim 1, wherein the filtering characteristic is a cut-off frequency of the filter.

3. The display unit according to claim 1, wherein the frequency determiner comprises:
a clock signal generator that generates a clock signal higher in frequency than a reference clock signal;
a sampler that samples the noise signal in accordance with the generated clock signal;
a level detector that detects a level of the sampled noise signal; and
a frequency calculator that calculates the frequency of the noise signal based on the detected level of the sampled noise signal.

4. The display unit according to claim 3, wherein the higher-frequency clock signal is generated by multiplication of the reference clock signal.

5. The display unit according to claim 3, wherein the higher-frequency clock signal is generated by delaying the reference clock signal.

6. The display unit according to claim 3, wherein the higher-frequency clock signal is generated by shifting a phase of the reference clock signal.
